(19) United States
(12) Patent Application Publication
(10) Pub. No.: US 2023/0133569 A1
(43) Pub. Date: May 4, 2023

(54) SELF-CHECKOUT OFFER PROCESSING

(71) Applicant: NCR Corporation, Atlanta, GA (US)

(72) Inventors: Aleah Jean Kadry, Atlanta, GA (US); Cole Chalhub, Atlanta, GA (US); Kip Oliver Morgan, Atlanta, GA (US); Lucas Edward Smith, Dunwoody, GA (US); Sohan Sathyan, Atlanta, GA (US); Ishita Soni, Marietta, GA (US)

(21) Appl. No.: 17/513,431

(22) Filed: Oct. 28, 2021

(51) Int. Cl. G06Q 20/18; G06N 20/00; G06Q 30/02; G06Q 20/36; G06Q 20/32

(52) U.S. Cl. CPC G06Q 20/18; G06N 20/00; G06Q 20/363; G06Q 20/3224; G06Q 20/3276; G06Q 30/0203; G06Q 30/0224; G06Q 30/0235; G06Q 30/0237

(57) ABSTRACT

During an in-store shopping journey of a customer, offers are identified based on a variety of personalized information known for the customer, known for the store, whether the customer is at a beginning or an end of their journey, items the customer is in process of buying during a self-checkout, items already in a basket of items for the customer, and/or items in close proximity to the customer’s location within the store. The offers are provided to the customer within an interface of the customer’s mobile shopping application or a Self-Service Terminal (SST). Any selected offer from the interface is automatically stored in an account of or a digital wallet of the customer or any selected offer is sent as a code to the customer’s mobile device. In an embodiment, stored offers are automatically added to a shopping list maintained for the customer for a next visit/journey to the store.

### BACKGROUND

In the highly competitive retail industry, retailers are fiercely competitive in attempting to reach consumers, retain their customers, and sell more product to their customers. A common practice used in the industry is to provide customers offers at a time and at a place that the retailer believes the customers will be more receptive to using the offer. A “conversion” is a term used in the industry to refer to a situation in which a customer was presented an offer and actually accepted the offer (redeemed the offer). The industry strives for high conversion rates rather than high contact rates with their customers because customers can become desensitized when provided too many offers too frequently resulting in negative customer reactions towards the retailer.

Most of the offers provided by retailers are provided via online channels (such as web browsers) while a consumer is browsing the Internet, visiting a specific website, shopping with a specific online retail store, or checking out of an online retail store. Third-party service provides often provide the offers on behalf of the retailer on the browser pages visited by the consumer using a variety of factors when deciding the content of the offers presented to the consumer.

Typically, when a consumer is shopping in a brick-and-mortar store, the checkout terminal will print (along with the receipt) a variety of offers to the consumer. The transaction has already completed, and it is unlikely that the consumer will re-enter the store and redeem the offer. More frequently, the consumer throws away the receipt or completely forgets about the offer, which is why these types of offers have low conversion rates.

Moreover, consumers are becoming more accustomed to performing self-checkouts via Self-Service Terminals (SSTs). This reduces staff needed to perform assisted customer checkouts of the retailers and alleviates the labor shortage, which retailers are facing due to COVID19 restrictions and due to the increased demand being experienced in the industry as the pandemic restrictions are eased.

Presenting offers on the SST displays during self-checkouts have been viewed unfavorably by retailers a variety of reasons. Customers were until recently largely unfamiliar with the customer interfaces and were reluctant to perform self-checkouts, such that adding other distractions to the interface screen during a checkout might cause customer confusion, anger, and/or delay transaction throughput as lines form of other customers waiting to access the SST during a delayed self-checkout. Also, self-redeeming an offer also presents challenges using the traditional model of a printed offer that has to be scanned or entered by the customer during a self-checkout and retained within a bin at the SST for auditing. Further, customers are reluctant and resistant to signing up for retail loyalty programs without sufficient incentive being offered and many offers require loyalty sign up, which is something that infrequently occurs during a self-checkout.

Large technology companies have become what they are today by providing a platform that monetized and integrated retail advertisements into the browsing experience of consumers. Yet, conversion rates for these browser provided advertisements are significantly lower than conversion rates on offers provided at brick-and-mortar stores. Accordingly, retailers have yet to optimally figure out a technique by which they can monetize their offers while their customers are in their stores already shopping (an optimal time to present offers).

### SUMMARY

In various embodiments, methods and a system for providing self-checkout offers are presented.

According to an aspect, a method for providing a self-checkout offer, is presented.

### BRIEF DESCRIPTION OF THE DRAWINGS

FIG. 1 is a diagram of a system for providing self-checkout offers, according to an example embodiment.

FIG. 2 is a diagram of a method for providing a self-checkout offer, according to an example embodiment.

FIG. 3 is a diagram of another method for providing a self-checkout offer, according to an example embodiment.

### DETAILED DESCRIPTION

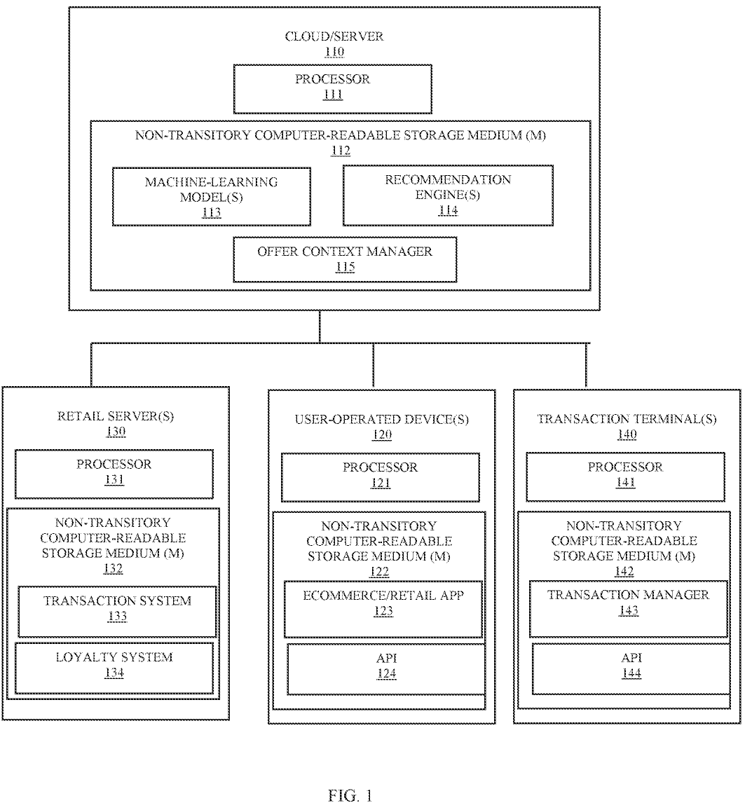

FIG. 1 is a diagram of a system 100 providing self-checkout offers, according to an example embodiment. It is to be noted that the components are shown schematically in greatly simplified form, with only those components relevant to understanding of the embodiments being illustrated.

Furthermore, the various components (that are identified in FIG. 1) are illustrated and the arrangement of the components is presented for purposes of illustration only. It is to be noted that other arrangements with more or less components are possible without departing from the teachings of self-checkout offer processing as presented herein and below.

As will be discussed in the various embodiments that follow, the teachings provide techniques by which offers are provided to an interface of a device operated by a customer during a shopping visit/journey to a brick-and-mortar store. The types of offers provided and the timings of each offer during the journey are also dynamically determined based on a variety of factors and features. Each offer is integrated and presented within the interface of the device that the customer is operating. When an offer is selected it can be provided to the customer in a variety of automatic manners, such as stored in a digital wallet associated with a retail application of a retailer associated with the store, stored in a loyalty account that the customer maintains with the retailer, or sent as a text message code to a mobile device of the customer. For any customer-app based shopping list or loyalty-based shopping list, the select offers are added to the shopping list for inclusion in a next visit of the customer to the store. During self-checkout any stored offers in the loyalty account or a digital wallet of the app are automatically provided for redemption when an item associated with the offer is detected as being purchased by the customer. Redeemed and non-redeemed offers are tracked, and revisions are made to the determination of future offers provided to the customer based on known redemptions and known non-redemptions for previous offers made to the customer. As a result, the selection process of determining the offers that are made to the customer improves over time with self-learning (redemption conversion rates are improved). When a self-checkout completes, a final in-store visit or final journey offer may be provided to the customer through the interface or a Quick Response (QR) code is displayed within the interface, which when captured by a camera of a customer mobile device directs the customer to a feedback questionnaire.

System 100 comprises a cloud/server 110, a plurality of customer-operated devices 120, one or more retail servers 130, and a plurality of in-store transaction terminals 140.

Cloud/Server 110 comprises at least one processor 111 and a non-transitory computer-readable storage medium 112. Medium 112 comprises executable instructions for one or more machine-learning models (algorithms) 113, one or more recommendation engines 114, and an offer context manager 115. The executable instructions when executed by processor 111 from the medium 112 cause processor 111 to perform operations discussed herein and below with model(s) 113, engine(s) 114, and context manager 115.

Each customer-operated device 120 comprises a processor 121 and a non-transitory computer-readable storage medium 122. Medium 122 comprises executable instructions for an ecommerce/retail application (app) 123 and an Application Programming Interface (API) 124. The executable instructions when executed by processor 121 from medium 122 cause processor 121 to perform operations discussed herein and below with respect to app 123 and API 124.

Each retail server 130 comprises a processor 131 and a non-transitory computer-readable storage medium 132. Medium 132 comprises executable instructions for a transaction system 133 and a loyalty system 134. The executable instructions when executed by processor 131 from medium 132 cause processor 131 to perform operations discussed herein and below with respect to transaction system 133 and loyalty system 134.

Each transaction terminal 140 comprises a processor 141 and a non-transitory computer-readable storage medium 142. Medium 142 comprises executable instructions for a transaction manager 143 and an API 144. The executable instructions when executed by processor 141 from medium 142 cause processor 141 to perform operations discussed herein and below with respect to transaction manager 143 and API 144.

A variety of data is obtained and processed to determine what type of offer to provide to the customer during a shopping journey and determine what point in time that the offer is to be provided to the customer. Any provided offer is provided through a customer-facing interface of ecommerce/retail app 123 using API 124 and/or provided through a customer-facing interface of transaction manager 143 using API 144.

In the case a given offer is provided through the customer-facing interface of transaction manager 143, the location and size of the offer presented within an offer screen is determined through interaction of offer context manager 115 and API 144. Similarly, when a given offer is provided through the customer-facing interface of ecommerce/retail app 123, the location and size of the offer presented within an offer screen is determined through interface of offer context manager 115 and API 124. API 144 may be configured to report transaction screen sizes (display coordinates) for transaction screens rendered by the customer-facing interface of transaction manager 143 and total available display space/dimensions available on a display of terminal 140 (based on display type or display settings for the display). This allows API 114 to calculate available locations and sizes for an offer screen of an offer on terminal 140. In the case of ecommerce/retail app 123, API 124 reports the display type, size, dimensions for a display associated with customer-operated device 120 to determine a max size of the offer screen, which may be presented as a popup that completely overlays the transaction screen or that partially overlays the transaction screen.

A variety of information is processed as features to determine what type of offer or the content/subject matter of an offer for any given customer during any given visit/journey to a given retail store. Example features include data selected from a product catalogue of the store (available through transaction system 133), loyalty information for the customer (available through loyalty system 134), transaction history data available for the store as a whole through transaction system 133 and/or available for a transaction history of the customer through loyalty system 134, location data reported by customer-operated device 120 combined with planogram data available for the item stocking layout of the store from transaction system 133, current item scan information or current basket information for the customer at the store as the customer is scanning items for purchase during the journey (provided by transaction manager 143 or ecommerce/retail app 123), a timing/state of the customer’s journey (beginning state (just arrived at the store), moving around the store state to collect items, scanning items state during checkout, initiated payment state for checkout, and checkout completed state where the customer is ready to exit the store), a current time of day, a current day of week, a current calendar date, types of businesses in close proximity to the store, and types of services or products offered by the businesses in close proximity to the store.

The features can be evaluated during each state of the customer during the journey using custom heuristics (rules), by using a trained machine-learning module (algorithm) 113, and/or using a hybrid that uses both heuristics and model 113.

A model-based and/or hybrid approach includes training model 113 on known customer journeys to the store where results of providing offers to the customers are known and it is known whether or not the customers actually redeemed the provided offers. Each journey comprises a training record processed to develop the model 113. Each training record comprises input data for each of the features discussed above customized for each customer and each journey. Each training record also comprises an expected output from the input that the model 113 is to use to weight the features and derive an algorithm that when provided a new in-progress customer journey record with the features being provided for a given journey state in real time as they are known for the customer, the model 113 produces as output an offer type believed to likely result in a conversion. Model 113 may also be trained on customer journeys associated with customers that selected and stored a given offer during a given journey state but failed to redeem the offer. The model can be tested and refined by using the customer journeys for which the customers did not select and store the offers.

Offer context manager 115 monitors a given customer’s journey to a given store from beginning to end using data obtained from transaction system 133, loyalty system 134, API 124 for ecommerce/retail app 123, and/or API 144 for transaction manager 143. For each journey state in the journey, offer context manager selectively obtains the feature input data and may provide the feature input data to a heuristic recommendation engine 114 for providing an offer, may provide the feature input data to model 113 for providing the offer, or may provide the feature input data to both model 113 and engine 114 (hybrid). Output from model 113 and/or engine 114 includes an offer that given the context and the journey state of this specific customer is most likely (highest probability) to result in the customer at least selecting and storing the offer during the current journey state for the customer’s journey.

In an embodiment, a hybrid approach is used where the top to 10% (or configurable percentage) of offers determined by both model 113 and engine 114 are compared by context manager 115 and the offer to provide is selected by context manager based on the comparison of two separate offer lists suggested by model 113 and engine 114. For example, both model 113 and engine 114 may include offer X but remaining offers included by both model 113 and engine 114 do not overlap, such that context manager 115 selects X as the offer to provide to the customer even if X was not the top selection of either model 113 or engine 114 or even if X was only the top selection of one of model 113 and engine 114.

Once the optimal offer is selected by context manager 115, the offer is provided to API 124 (when the customer is shopping using app 123) for presenting within an offer screen on the display of device 120 adjacent to or overlaid on an existing transaction screen provided by app 123 or the offer is provided to API 144 (when the customer is checking out at terminal 140 using transaction manager 143) for presenting within an offer screen on the display of terminal 140 adjacent to or overlaid on an existing transaction screen provided by transaction manager 143.

API 124 and API 144 monitor the offer screen that comprises the offer and when the customer selects the screen, API 124 and 144 sends the selection notification to offer context manager 115. Context manager 115 determines whether the customer is known and has a loyalty account with the retailer, known and has a digital wallet associated with app 123, known and has an existing shopping list or maintains shopping lists associated with app 123 or associated with a loyalty account of the store (retailer), known and has a loyalty account with the retailer, or is unknown without any loyalty account known to the retailer. When the customer has a known loyalty account a profile of the customer may include an option that directed context manager 115 what to do with the selected offer, such as store in a digital wallet of app 123, store in the loyalty account, and/or store in a further or existing shopping list associated with the customer.

When the customer is unknown or lacks a loyalty account and is operating terminal 140 during a checkout transaction at the store, context manager 115 interacts with API 144 to render a loyalty enrollment incentive within the offer screen on the display of terminal 140. When selected by the customer, an enrollment interface is proxied through API 144 and Offer context manager into enrollment screens on the transaction terminal display for the customer to enter information required for creating a loyalty account. The loyalty incentive offer is awarded and may be integrated into the customer’s current transaction through API 144 interacting with transaction manager 143.

When the customer is unknown and declines loyalty enrollment, context manager detects selection of the offer through API 144 within the offer screen and provides a second screen for the customer to enter either a mobile device phone number of the customer or an email of the customer, if the customer provides that information, the code associated with the offer selected by the customer is sent via text message to the customer’s mobile device of via email to the customer. The code can be scanned by the customer to redeem the offer from the the customer’s text messaging app or from the customer’s email app when the customer desires to redeem the offer.

When the customer completes and finishes payment for the customer’s transaction either on customer mobile device 120 or terminal 140, another optimal offer may be presented through the offer screen for businesses and services adjacent to or in the vicinity of the store, such as a coffee shop, haircut, etc.

Still further when the customer completes and finishes payment for the customer’s transaction, offer context manager 115 may interact with API 124 or API 144 to provides a QR code for feedback or a survey of the customer. The survey can be scanned or automatically activated on customer-mobile device 120 by clicking on the QR code, when scanned by device 120 from the display of terminal 140, a browser on device 120 is redirected to the feedback questionnaire or survey. Feedback selections and input are recorded and may be used as new features for training and consideration with heuristic rules of engine 114 and/or machine-learning model 113. The feedback inputted by the customer may then be weighted more heavily by engine 114 or model 113 in subsequent delivery of offers for the customer during subsequent journeys to the store for each journey state.

In an embodiment, offer context manager 115 may monitor offers and expiration dates of those offers from a customer’s digital wallet or loyalty account and at configured period of times manager 115 may send reminders to the customer about redeeming the offers via API 124, ecommerce/retail app 123, and/or text messages to device 120. The timing of the reminders may be set in a profile by the customer or may be prompt the notifications at default intervals of time after the offer was provided to the customer and/or before a set expiration data of the offer is set to expire. In an embodiment, location information reported by app 123 may also be used by manager 115 to send dynamic reminders when the customer is detected as being present at the store, manager 115 may remind the customer that the offer is available and has not been redeemed for the store upon entry into the store.

In an embodiment, during a scanning items state for the journey of a given customer, as each item code is scanned, context manager obtains the item description and details from the product catalogue via transaction system 133 and utilizes one or more of model 113 and/or engine 114 to update an offer being provided by API 124 on device 120 or by API 144 on terminal 140. This adjusts features being used to determine an optimal offer based on the newly acquired product information and further based on the then-existing basket details for previous items scanned for the transaction during checkout. Thus, during the scanning items state, offer context manager 115 may provide a new optimal offer within the offer screen managed by API 124 or 144 for as each new item for the transaction is scanned by the customer.

In an embodiment, during a checkout completed state or a beginning state of a customer’s journey, a currently location reported by app 123 to context manager 115 and compared against planogram data obtained for the store from transaction system 133. The context manager 115 may utilizes engine 114 for heuristically determining an offer for an item that is withing a configurable distance of the customer (such as a Coke® in a Coke® display) and render a first offer via an offer screen rendered on the display of device 120 using API 124. That is, the available offers from which engine 114 can select during a beginning state is location restricted based on the customer’s current location relative to items within a configured distance of the current location.

In an embodiment, during a checkout completed state of the customer during the journey, offer context manager 115 may restrict the offers for items still within the store or include services of business in proximity to the store in the pool of available offers to provide to the customer as a last optimal offer made to the customer before the customer exits the store and completes the journey.

In an embodiment, model 113 and/or engine 114 may receive as input from offer context manager 115 a list of available offers for selection of an optimal offer during any given state of the journey. Model 113 and/or engine 114 then scores or ranks based on probabilities a highest probability offer from the list of available offers and provides the optimal offer to context manager 115. Context manager 115 may continuously restrict the universe of offers to select by model 113 and engine 114 with each request for an offer during a given state. Restriction of the universe can be location based as discussed above based on a current location of the customer (while moving around the store with device 120 or while stationary at terminal 140). Restriction of the universe may also be based on customer-profile settings, such as no item above X price, a customer-provided list of items for which the customer does not want to see any offer for, a customer-provided level of interest in types of items or brands of items, etc.

In an embodiment, ecommerce app 123 is an existing third-party shopping app that is enhanced for interaction with API 123.

In an embodiment, retail app 123 is an existing third-party retailer shopping app that is enhanced for interaction with API 123.

In an embodiment, model 113, engine 114, and/or context manager 115 are subsumed and processed on a specific retail server 130.

In an embodiment, model 113, engine 114, and/or context manager 115 are subsumed and processes on a specific third-party shopping service’s server.

In an embodiment, the transaction terminal 140 is an SST, a Point-Of-Sale (POS) terminal, a tablet computer, or a laptop computer.

In an embodiment, customer-operated device 120 is a mobile device and the mobile device is a phone, glasses, a watch, a tablet, or a laptop computer.

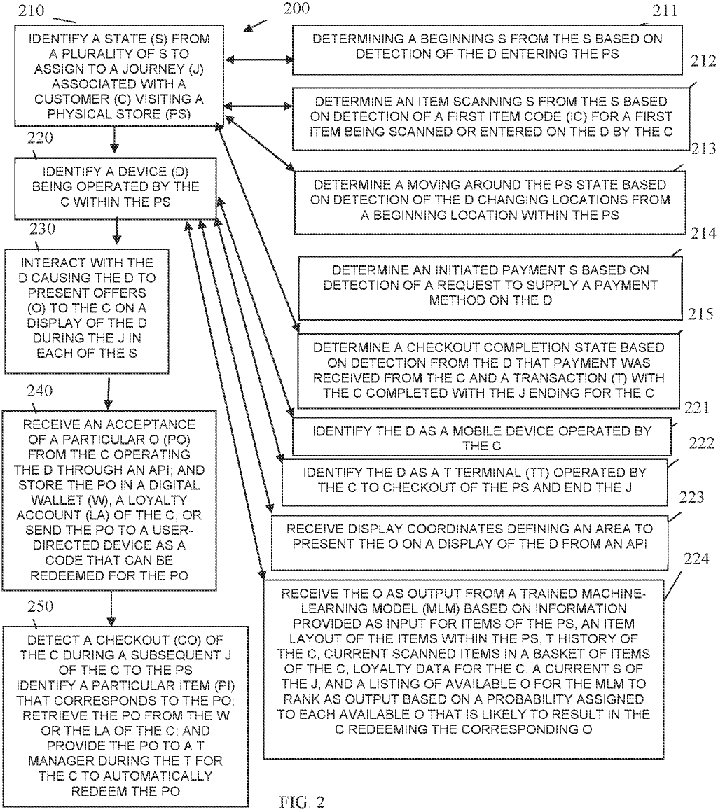

The above-referenced embodiments and other embodiments are now discussed with reference to FIGS. 2—3.

FIG. 2 is a diagram of a method 200 for providing a self-checkout offer, according to an example embodiment. The software module(s) that implements the method 200 is referred to as an “in-store offer manager.” The in-store offer manager is implemented as executable instructions programmed and residing within memory and/or a non-transitory computer-readable (processor-readable) storage medium and executed by one or more processors of one or more devices. The processor(s) of the device(s) that executes the in-store offer manager are specifically configured and programmed to process the in-store offer manager. The in-store offer manager has access to one or more network connections during its processing. The connections can be wired, wireless, or a combination of wired and wireless.

In an embodiment, the device that executes the in-store offer manager is cloud 110. In an embodiment, the device that executes in-store offer manager is server 110.

In an embodiment, the device that executes the in-store offer manager is retail server 130.

In an embodiment, the device that executes the in-store offer manager is a server associated with a third-party shopping service.

In an embodiment, the in-store offer manager is all of, or some combination of model(s) 113, engine 114, and/or offer context manager 115.

At 210, in-store offer manager identifies a state from a plurality of states to assign to a journey/visit associated with a customer that is visiting a physical store.

In an embodiment, at 211, the in-store offer manager determines a beginning state from the states based on detection of the device 120 entering the physical store.

In an embodiment, at 212, the in-store offer manager determines an item scanning state from the states based on detection of a first item code for a first item being scanned or entered on the device 120 or 140 by the customer.

In an embodiment, at 213, the in-store offer manager determines a moving around the physical store state from the states based on detection of the device 120 changing locations from a beginning location within the physical store.

In an embodiment, at 214, the in-store offer manager determines an initiated payment state for the states based on detection of a request to supply a payment method on the device 120 or 140.

In an embodiment, at 215, the in-store offer manager determines a checkout completion state for the states based on detection from the device 120 or 140 that payment was received from the customer and a transaction with the customer completed with the journey ending for the customer.

At 220, the in-store offer manager identifies a device 120 or 140 being operated by the customer within the physical store.

In an embodiment, at 221, the in-store offer manager identifies the device as a mobile device 120 operated by the customer.

In an embodiment, at 222, the in-store offer manager identifies the device 140 as a transaction terminal (SST 140) operated by the customer to self-checkout of the physical store and end the journey.

In an embodiment, at 223, the in-store offer manager receives display coordinates defining an area to present the offers on a display of the device 120 or 140 from an API 124 or 144, respectively.

In an embodiment, at 224, the in-store offer manager receives the offers as output from a trained-machine learning model 113 based on information provides as input for items of the physical store, an item layout of items within the physical store (current planogram), a transaction history of the customer, loyalty data for the customer (including customer profile and preferences), current scanned items in a basket of items of the customer, a current state of the journey, and a listing of filtered or available offers for the MLM 113 to rank as output based on a probability assigned to each available offer that is likely to result in the customer redeeming the corresponding offer.

At 230, the in-store offer manager interacts with the device causing the device 120 or 140 to present the offers to the customer on a display of the device 120 or 140 during the journey in each of the states.

In an embodiment, at 240, the in-store offer manager receives an acceptance or selection of a particular one of the offers from the customer operating the device 120 or 140 through an API 124 or 144, respectively. In response to the acceptance of selection, the in-store offer manager stores the particular offer in a digital wallet or a loyalty account of the customer or the in-store offer manager sends the particular offer to a customer-directed device (can be 120) as a code that can be redeemed for the particular order.

In an embodiment of 240 and at 250, the in-store offer manager detects a checkout of the customer during a subsequent journey of the customer to the physical store. The in-store offer manager identifies a particular item that corresponds to the particular offer, retrieves the particular offer from the digital wallet or the loyalty account of the customer, and provides the particular offer to a transaction manager 123 or 143 during the transaction for the customer to automatically redeem the particular order.

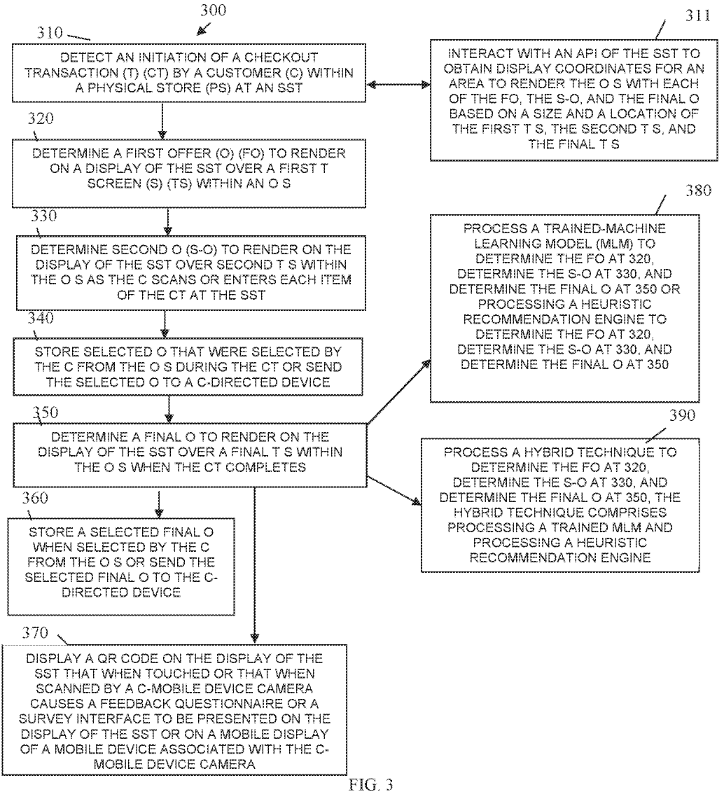

FIG. 3 is a diagram of another method 300 for providing a self-checkout offer, according to an example embodiment. The software module(s) that implements the method 300 is referred to as an “offer contact manager.” The offer contact manager is implemented as executable instructions programmed and residing within memory and/or a non-transitory computer-readable (processor-readable) storage medium and executed by one or more processors of one or more devices. The processor(s) of the device(s) that executes the offer contact manager are specifically configured and programmed to process the offer contact manager. The offer contact manager has access to one or more network connections during its processing. The network connections can be wired, wireless, or a combination of wired and wireless.

In an embodiment, the device that executes the offer contact manager is cloud 110. In an embodiment, the device that executes the offer contact manager is server 110.

In an embodiment, the device that executes the offer contact manager is retail server 130.

In an embodiment, the device that executes the offer contact manager is a server associated with a third-party shopping service.

In an embodiment, the offer contact manager is all of, or some combination of model(s) 113, engine(s) 114, offer context manager 115, and/or method 200.

The offer contact manager presents another, and in some ways, enhanced processing perspective from that which was discussed above for method 200 and system 100.

At 310, the offer contact manager detects an initiate of a checkout transaction by a customer within a physical store at an SST 140.

In an embodiment, at 311, the offer contact manager interacts within an API 144 of the SST 140 to obtain display coordinates from an area to render an offer screen with each of the provided offers (see 320, 330, and 350 below) based on a size and a location of each transaction interface screen (see 320, 330, and 350) already rendered on the display of the SST 140 during the checkout transaction.

At 320, the offer contact manager determines a first offer to render on a display of the SST 140 over a first transaction interface screen within the offer screen (optionally dynamically sized based on 311).

At 330, the offer contact manager determines second offers to render on the display of the SST 140 over second transaction interfaces screens within the offer screen as the customer scans or enters each item of the checkout transaction at the SST 140. So, the context by which the second offers are determine changes as items of the customers basket becomes known and as each item becomes known.

At 340, the offer contact manager stores elected offers that were selected by the customer from the offer screen during the checkout transaction or the offer contact manager sends the selected offers to a customer-directed device or customer-directed email account.

At 350, the offer contact manager determines a final offer to render on the display of the SST 140 over a final transaction interface screen within the offer screen when the checkout transaction completes.

In an embodiment, at 360, the offer contact manager stores a selected final offer when selected by the customer from the offer screen or the offer contact manager sends the selected final offer to the customer-directed device of customer-directed email account.

In an embodiment, at 370, the offer contact manager displays a QR code on the display of the SST 140 that when touched or that when scanned by a customer-mobile device camera causes a feedback questionnaire or a survey interface to be presented on the display of the SST 140 or on a mobile display of a mobile device 120 associated with the customer-mobile device camera.

In an embodiment, at 380, the offer contact manager processes a trained MLM 113 to determine the first offer at 320, determine the second offers at 330, and determine the final offer at 350 or the offer contact manager processes a heuristic recommendation engine 114 to determine the first offer at 320, determine the second offers at 330, and determine the final offer at 350.

In an embodiment, at 390, the offer contact manager processes a hybrid technique to determine the first offer at 320, the second offers at 330, and the final offer at 350. The hybrid technique comprises processing a trained MLM 113 and processing a heuristic recommendation engine 114 and selecting each of the offers based on output offers provided by the MLM 113 and engine 114 and based on rules evaluated in view of the output from MLM 113 and engine 114.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
identifying a state from a plurality of states to assign to a journey associated with a customer visiting a physical store;
identifying a device being operated by the customer within the physical store; and
interacting with the device causing the device to present offers to the customer on a display of the device during the journey in each of the states.

2. The method of claim 1, wherein identifying the state further includes determining a beginning state from the states based on detection of the device entering the physical store.

3. The method of claim 1, wherein identifying the state further includes determining an item scanning state from the states based on detection of a first item code for a first item being scanned or entered on the device by the customer.

4. The method of claim 1, wherein identifying the state further includes determining a moving around the physical store state based on detection of the device changing locations from a beginning location within the physical store.

5. The method of claim 1, wherein identifying the state further includes determining an initiated payment state based on detection of a request to supply a payment method on the device.

6. The method of claim 1, wherein identifying the state further includes determining a checkout completion state based on detection from the device that payment was received from the customer and a transaction with the customer completed with the journey ending for the customer.

7. The method of claim 1, wherein identifying the device further includes identifying the device as a mobile device operated by the customer.

8. The method of claim 1, wherein identifying the device further includes identifying the device as a transaction terminal operated by the customer to checkout of the physical store and end the journey.

9. The method of claim 1, wherein interacting further includes receiving display coordinates defining an area to present the offers on a display of the device from an Application Programming Interface (API).

10. The method of claim 9, wherein interacting further includes receiving the offers as output from a trained machine-learning model based on information provided to the trained machine-learning model as input for items of the physical store, an item layout of the items within the physical store, transaction history of the customer, current scanned items in a basket of items of the customer, loyalty data for the customer, a current state of the journey, and a listing off available offers for the trained machine-learning model to rank as the output based on a probability assigned to each available offer that is likely to result in the customer redeeming the corresponding offer.

11. The method of claim 1 further comprising:
receiving an acceptance of a particular offer from the customer operating the device through an Application Programming Interface (API) and
storing the particular offer in a digital wallet of the customer, a loyalty account of the customer, or sending the particular offer to a customer-directed device as a code that can be redeemed for the particular offer.

12. The method of claim 11 further comprising:
detecting a checkout of the customer during a subsequent journey of the customer to the physical store;
identifying a particular item that corresponds to the particular offer;
retrieving the particular offer from the digital wallet or the loyalty account of the customer; and
providing the particular offer to a transaction manager during the transaction for the customer to automatically redeem the particular offer.

13. A method, comprising:
detecting initiation of a checkout transaction by a customer within a physical store at a Self-Service Terminal (SST);
determining a first offer to render on a display of the SST over a first transaction interface screen within an offer screen;
determining second offers to render on the display of the SST over second transaction interface screens within the offer screen as the customer scans or enters each item of the checkout transaction at the SST;
storing selected offers that were selected by the customer from the offer screen during the checkout transaction or sending the selected offers to a customer-directed device;
determining a final offer to render on the display of the SST over a final transaction interface screen within the offer screen when the checkout transaction completes.

14. The method of claim 13 further comprising storing a selected final offer when selected by the customer from the offer screen or sending the selected final offer to the customer-directed device.

15. The method of claim 13 further comprising, displaying a Quick Response (QR) code on the display that when touched or that when scanned by a customer-mobile device camera causes a feedback questionnaire or a survey interface to be presented on the display of the SST or on a mobile display of a mobile device associated with the customer-mobile device camera.

16. The method of claim 13, wherein detecting further includes interacting with an Application Programming Interface (API) of the SST to obtain display coordinates for an area to render the offer screen with each of the first offer, the second offers, and the final offer based on the size and location of the first transaction interface screen, the second transaction interface screens, and the final transaction interface screen.

17. The method of claim 13 further comprising, processing a trained machine learning algorithm to determine the first offer, determine the second offers, and determine the final offer or processing a heuristic recommendation engine to determine the first offer, determine the second offers, and determine the final offer.

18. The method of claim 13 further comprising, processing a hybrid technique to determine the first offer, determine the second offers, and determine the final offer, wherein the hybrid technique comprises processing a trained machine learning algorithm and processing a heuristic recommendation engine.

19. A system, comprising:
a server comprising a processor and a non-transitory computer-readable storage medium;
the non-transitory computer-readable storage medium comprises executable instructions; and
the executable instructions when executed by the processor from the non-transitory computer-readable storage medium cause the processor to perform operations, comprising:
monitoring a visit of a customer to a physical store;
obtaining data relevant to the customer and the store;
identifying states of the visit as the customer moves around the store and checkouts of the store with items;
determining offers to present on one or more devices operated by the customer within the store based on the data and based on a current state of the states; and
rendering the offers on a display of the one or more devices during each of the states.

20. The system of claim 19, wherein the executable instructions when executed by the processor from the non-transitory computer-readable storage medium further cause the processor to perform additional operations, comprising:
storing selected offers that are selected by the customer from the one or more devices in a digital wallet or a loyalty account of the customer or sending a code representing the selected offers to a customer-directed device;
automatically applying the selected offers during subsequent visits of the customer to the physical store when the selected offers are stored in the digital wallet or the loyalty account when select items being purchased by the customer during the subsequent visits correspond to conditions of the selected offers;
tracking redemptions of the selected offers by the customer and using the selected offers to retrain a machine-learning model that provides the offers during each of the states; and
periodically raising a notification at configured intervals of time for unused selected offers to the customer on a customer device when the unused selected offers are approaching expiration dates for redemption.
